(19) United States
(12) Patent Application Publication
(10) Pub. No.: US 2025/0279668 A1
(43) Pub. Date: Sep. 4, 2025

(54) SYSTEMS AND METHODS FOR CHARGING A SUBSEA POWER SUPPLY USING SILICON CARBIDE SWITCHING

(71) Applicant: Chevron U.S.A. Inc., San Ramon, CA (US)

(72) Inventors: Masoud Hajiaghajani, Houston, TX (US); Lee Eric Mitchell, Katy, TX (US); John Eric Bodine, Katy, TX (US); Gregory Joseph Clement, Sugar Land, TX (US); Richard S. Kopps, Sugar Land, TX (US)

(21) Appl. No.: 18/592,491

(22) Filed: Feb. 29, 2024

(51) Int. Cl. H02J 7/06; H02J 9/06

(52) U.S. Cl. CPC H02J 7/06; H02J 9/06; H02J 2207/20

(57) ABSTRACT

A system for providing power to subsea equipment includes: a subsea power supply; a subsea load operably coupled to the subsea power supply to selectively receive operational power from the subsea power supply; a subsea charger electrically coupled to the subsea power supply and configured to charge the subsea power supply, wherein the subsea charger includes a power converter comprising multiple silicon carbide (SiC) switches; and at least one power generation unit operably coupled to the subsea power supply charger.

### FIELD OF THE INVENTION

The disclosed invention is directed generally to systems and methods for charging subsea power supplies and, more particularly, to methods and applications of silicon carbide switching technology in a subsea battery charger or a subsea uninterruptible power supply (UPS) powered from a conventional power source or renewable power source.

### BACKGROUND AND SUMMARY

There is often a desire to transmit power to subsea equipment to support offshore projects such as compression and pumping of natural gas, hydrocarbon exploration, hydrocarbon recovery, charging stations and the like. Such power is usually transmitted through an umbilical carrying AC power or a DC power/fiber optic cable (DC/FO cable). In the event of unexpected malfunction of such transmission media, it is desirable to maintain the power supply to subsea equipment so that production (or other operations) does not stop. Subsea batteries or subsea uninterruptible power supplies (UPSs) are being developed to provide a backup power supply to subsea equipment for events when the regular umbilical or cable provided power is interrupted. Unfortunately, available methods for charging subsea batteries or UPSs involve systems that can be large and difficult to deploy. It is now recognized that a need exists for a subsea power supply charger with a small footprint that can be more easily deployed to subsea locations. Advantageously, the systems and methods described herein meet the aforementioned needs and more.

In one embodiment, the application pertains to a system for providing power to subsea equipment. The system includes a subsea power supply and a subsea load operably coupled to the subsea power supply to selectively receive operational power from the subsea power supply. The system also includes a subsea charger electrically coupled to the subsea power supply and configured to charge the subsea power supply. The subsea charger includes a power converter comprising multiple silicon carbide (SiC) switches. The system further includes at least one power generation unit operably coupled to the subsea power supply charger.

In another embodiment, the application pertains to a method that includes transmitting power from at least one power generation unit to a subsea charger. The method also includes charging a subsea power supply via the subsea charger. The subsea charger includes a power converter including multiple silicon carbide (SiC) switches. The method further includes selectively supplying power to a subsea load via the subsea power supply.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 shows a schematic diagram of an example subsea charger using silicon carbide switches according to an example embodiment.

FIG. 2 shows a schematic block diagram illustrating a representative application of a system including a subsea charger according to an example embodiment.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

The systems and methods described herein may be used to charge a subsea power supply. A subsea power supply may include a subsea battery or a subsea UPS. The disclosed systems and methods for charging such subsea power supplies incorporate silicon carbide (SiC) switching technology to reduce the footprint of the charging equipment. SiC technology can provide high-density power conversion in a small footprint. SiC switches in a subsea power converter could allow trickle charging of subsea batteries using multiple charging sources, such as a tie-in to a conventional AC or DC umbilical or a downline umbilical, powered from a renewable power source or a clean power source. A renewable power source may include a power generation system that generates power from wind, solar, wave, or sea current. A clean power source may include a power generation system that generates power from biomass, nuclear, or clean burning natural gas or liquid natural gas. The disclosed systems and methods for charging a subsea power supply may support the operations of an all-electric subsea system.

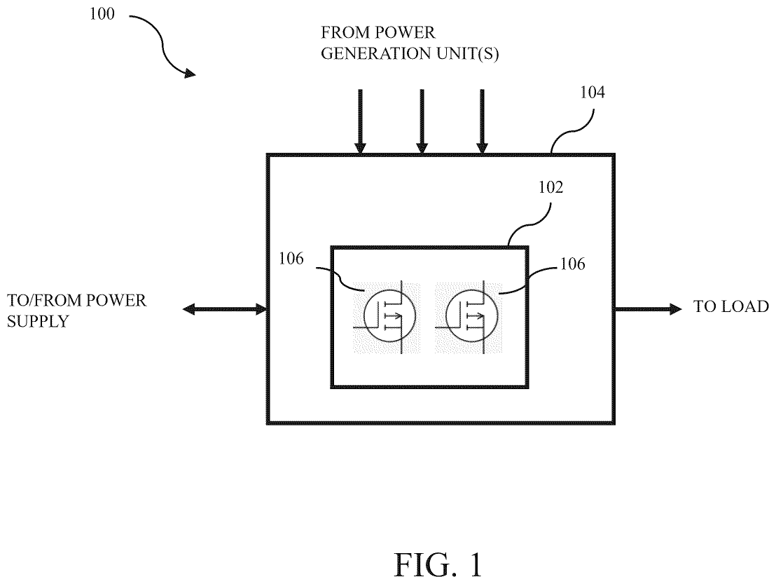

Turning now to the drawings, FIG. 1 shows an example embodiment of a subsea power supply charger (“subsea charger”) 100 that uses SiC switching. The subsea charger 100 comprises a power converter 102 located in an enclosure 104 suitable for subsea environments. The charger 100 is configured to be positioned subsea during its operation to charge a subsea power supply. The subsea power supply may be a subsea battery or a subsea UPS. The enclosure 104 may be a dedicated enclosure for the charger 100 such that the charger 100 is a standalone apparatus that can be electrically coupled to one or more other subsea devices (e.g., a subsea power supply). In other embodiments, the enclosure 104 may include or may be incorporated into an enclosure for the subsea power supply, which the charger 100 is used to charge. In accordance with present embodiments, the power converter 102 includes multiple SiC switches 106 (e.g., MOSFETs) used to convert incoming electricity to a form suitable for charging the subsea power supply. The power converter 102 and its SiC switches 106 shown in FIG. 1 are representative and do not show the precise circuitry of such a power converter. The power converter 102 may have any desired topology. In some embodiments, the subsea charger 100 may be an inverter/charger. In some embodiments, the power converter 102 may include a buck converter or a boost converter.

As illustrated, the subsea charger 100 may be operably coupled in a bi-directional manner to the power supply. The subsea charger 100 may be coupled to and receive electrical power (AC or DC) from one or more power generation units, as shown. The subsea charger 100 may be coupled to a load. The load may be powered directly from the electrical power (AC or DC) provided from the one or more power generation units (via an umbilical or DC/FO cable) to the charger 100, or from electrical power (DC) supplied from the subsea power supply coupled to the charger 100. In some embodiments, the power supply may selectively provide operational power to the load, for example, when power is unavailable from a subsea umbilical or DC/FO cable.

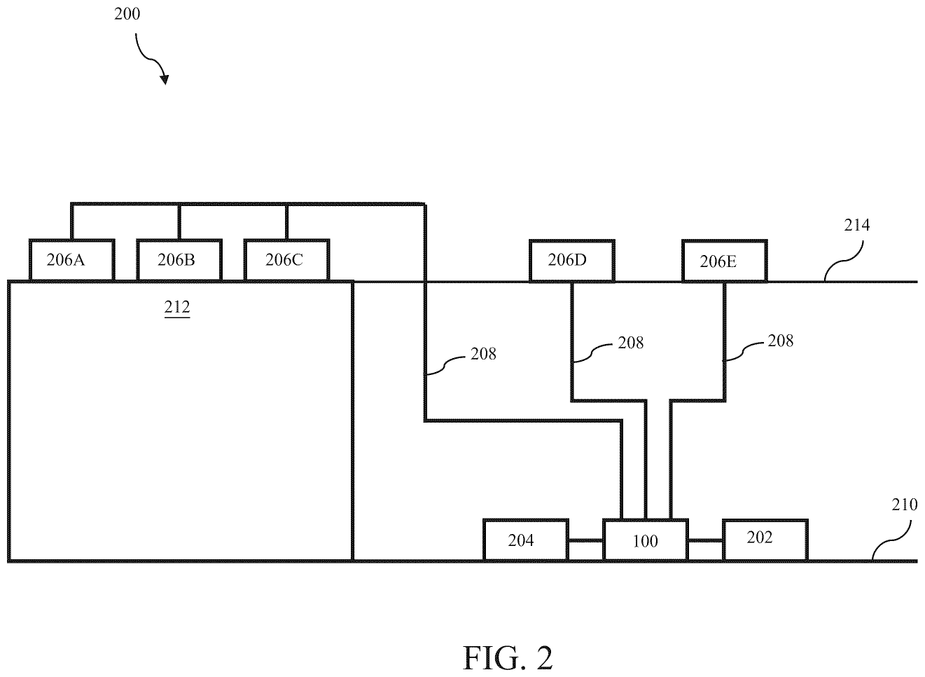

The systems of the present application can be configured in many different ways using various types of equipment in electrical communication with the subsea power supply charger. One exemplary embodiment of many different useful configurations is shown in FIG. 2. FIG. 2 shows an embodiment of a system 200 for providing power to subsea equipment (e.g., a load 202). As illustrated, the system 200 includes a subsea power supply 204 and the subsea load 202, which is operably coupled to the subsea power supply 204 to selectively receive operational power from the subsea power supply 204. The system 200 also includes the subsea charger 100, which is electrically coupled to the subsea power supply 204 and configured to charge the subsea power supply 204. As discussed above with respect to FIG. 1, the subsea charger 100 includes a power converter comprising multiple silicon carbide (SiC) switches. The system 200 further includes at least one power generation unit 206 operably coupled to the subsea charger 100. The power generation unit(s) 206 may be coupled to the subsea charger 100 via one or more power transmission lines 208 (e.g., subsea umbilical or DC/FO cable).

As illustrated, the subsea charger 100 may be located on the sea floor 210. In some embodiments, the subsea charger 100 may be located at a water depth up to about 3000 meters. The subsea power supply 204 and the load 202 may similarly be located on the sea floor 210 (e.g., at similar depths). As shown, the load 202 may be coupled (e.g., through the subsea charger 100) to the subsea power supply 204. Although only one load 202 is shown, it should be noted that in other embodiments multiple loads may be operably coupled to the subsea power supply 204 and configured to receive power therefrom. In some embodiments, one or more of the power generation units (e.g., 206A, 206B, and 206C in FIG. 1) may be located onshore (i.e., on land 212). In some embodiments, one or more of the power generation units (e.g., 206D and 206E in FIG. 1) may be located offshore (i.e., on the sea surface 214), such as on a fixed or floating facility. Although five power generation units 206 are shown in FIG. 2, other embodiments of the system may include fewer (e.g., 1, 2, 3, or 4) or a greater number of power generation units 206. The power transmission line(s) 208 coupling the one or more power generation units 206 to the subsea charger 100 may include one or more static land-based portions, static (e.g., along the sea floor 210) subsea portions, and/or dynamic subsea portions.

In operation, at least one power generation unit 206 may transmit power to the subsea charger 100 via a corresponding power transmission line 208. The subsea charger 100 may charge the subsea power supply 204 using at least a portion of the power transmitted from the power generation unit(s) 206. The subsea power supply 204 may then selectively supply power to the subsea load(s) 202.

The configuration of the subsea power supply 204, load 202, subsea charger 100, and power generation units 206A-E in FIG. 2 are exemplary, and it should be noted that other numbers and relative configurations of these components may be used in other embodiments without departing from the scope of the present disclosure. For example, in the illustrated embodiment, the subsea charger 100 is a standalone component separate from and coupled to the subsea power supply 204. In other embodiments, the subsea charger 100 may be integrated into the subsea power supply 204. For example, the subsea power supply 204 could be directly connected to the load(s) 202 and the subsea charger 100 embedded in the subsea power supply 204.

Having generally described the layout of the system 200, a more detailed description of the components of the system 200 will now be provided. The one or more power generation units 206 may include power generation stations, e.g., power plants, located onshore or offshore. For embodiments where one or more power generation units 206 are located onshore, the power transmission line(s) 208 connecting the power generation units 206 to the subsea charger 100 may be long tie-backs to the onshore equipment. In some embodiments the power plants may generate renewable energy or clean energy, e.g., from wind, solar, wave, current, biomass, clean burning natural gas or liquid natural gas, or a combination thereof. Different types of power generation units 206 may be used to charge the subsea power supply 204. For example, in the illustrated embodiment, the onshore power generation units 206A, 206B, and 206C may include an onshore power facility (e.g., a conventional power plant), an onshore wind energy installation (e.g., with one or more wind turbines), and an onshore solar energy installation (e.g., with one or more solar panels), respectively. In other embodiments, other onshore power generation units and/or a grid connection may be used. In the illustrated embodiment, the offshore power generation units 206D and 206E may include an offshore wind energy installation (e.g., with one or more wind turbines) and a wave energy generation unit (e.g., using one or more floating buoys to generate power from sea motion). In other embodiments, other types of offshore power generation units may be used such as a floating power generation station, a subsea current-based power generation unit, or some other subsea power generation unit. Although not shown, one or more receiving stations such as an offshore power station like a field control station (such as a semisubmersible power and control distribution floater) may be located between a power generation unit 206 and the subsea charger 100 and used to communicate power therethrough to the subsea charger 100.

The power transmission lines 208 may communicate AC or DC power from the one or more power generation units 206 to the subsea charger 100. In some embodiments, a power transmission line 208 may include a subsea umbilical configured to transmit AC power from one or more power generation units 206 to the subsea charger 100. To that end, the power converter in the subsea charger 100 may be structured such that the subsea charger 100 is a charger/inverter. The subsea umbilical may transmit AC power from one or more power generation units 206 to the subsea charger 100, which may be integrated in the same package as the subsea power supply 204 to allow trickle charging of the subsea power supply 204.

In other embodiments, the power transmission line 208 may include a DC/FO cable configured to transmit DC power from a power generation unit 206 to the subsea charger 100. To that end, the subsea charger 100 may be integrated with a subsea node of the DC/FO cable. The DC/FO cable may transmit DC power from one or more power generation units 206 to the subsea charger 100, and the power converter of the subsea charger 100 may include a DC buck converter or a DC boost converter.

The subsea power supply 204 may be a subsea battery or a subsea UPS. The subsea power supply 204 may function as a backup power supply for the connected load(s) 202 in certain embodiments. For example, the system 200 may supply power to a subsea load 202 via an umbilical or DC/FO cable during normal operations. The same or a different umbilical or DC/FO cable may provide power to the subsea power supply 204 to charge the power supply. Upon detecting an interruption in power from the umbilical or DC/FO cable being used to power the load 202, the system may switch over to the subsea power supply 204 powering the load 202. As such, the subsea power supply 204 may selectively power the load 202. Any available battery or UPS technology available for subsea operations may be used for the subsea power supply 204 without departing from the scope of the present disclosure.

The subsea load 202 may include any component of subsea equipment operating either partially or fully on electrical power. The subsea load 202 may similarly include any component of subsea equipment that can operate at least partially on electrical power but has previously operated solely on hydraulic power. For example, the subsea load 202 may include a subsea control unit, a subsea monitoring unit, a subsea processing unit, or a pressure protection system. The subsea load 202 may include any component of an all-electric subsea system.

In some embodiments, as illustrated, the subsea charger 100 may be electrically coupled to a single subsea power supply 204. In other embodiments, the subsea charger 100 may be electrically coupled in parallel to multiple subsea power supplies 204. Each subsea power supply 204 may be used to selectively power a different one or more load(s) 202. In other embodiments, the subsea charger 100 may be electrically coupled in parallel to multiple subsea power supplies 204 used to provide operational power to a single load 202 with a large power requirement.

The one or more subsea power supplies 204 (coupled to the subsea charger 100) may be configured to supply from about 5 kW of power to about 1 MW of power depending on the number of power supplies 204, the attached subsea load(s) 202, and the number of fields that are supported by the subsea power supplies 204. For example, in a system with one subsea power supply 204 supporting one field, where the load 202 includes a subsea control system that is partially electric and partially hydraulic, the power requirement may be in the range of from about 5 kW to about 10 kW. In other embodiments, the system may have a subsea power supply 204 supporting one field, where the load 202 includes a subsea control system that is fully electric, and the power requirement for the subsea power supply 204 may be from about 10 kW to about 20 kW. In other embodiments where the subsea charger 100 is attached to one or more subsea power supplies 204 attached to loads 202 in multiple fields (e.g., 2, 3, 4, 5, 6, 7, 8, 9, 10, or more fields), the power requirement for the subsea power supplies 204 may be higher, e.g., from about 10 kW to about 1 MW, from about 25 kW to about 500 kW, or from about 50 kW to about 100 kW. In embodiments where the load 202 includes a subsea pump, the power requirement for the one or more subsea power supplies 204 that can power the pump may be in the megawatt range.

As discussed above, the subsea charger 100 includes SiC switches, which can handle relatively high temperatures and voltages within a small footprint. For example, the subsea charger 100 can direct up to 15 kV higher switching voltages directly to a SiC switch than to conventionally used switches. Due to the SiC switches being energy dense in a small package, they may be better suited for use in subsea charger applications than other types of switches. The use of SiC switches reduces the overall size and weight of the charger 100 to be placed subsea. This is advantageous because, in the subsea world, any power conversion equipment (e.g., subsea charger 100) being installed at the sea floor 210 must have a sturdy enclosure around its electronics. Reducing the size and weight of the power electronics in the subsea charger 100 (by incorporating SiC switches) reduces the size and weight of the subsea charger 100 (including the enclosure 104 of FIG. 1), thereby reducing the installation costs of the system. In addition, at a later time, it may be desirable to scale up the capabilities of subsea chargers 100. As the power requirement for these chargers 100 increases, the reduced footprint available using SiC components makes the subsea charger 100 even more cost effective.

Although embodiments described herein are made with reference to example embodiments, it should be appreciated by those skilled in the art that various modifications are well within the scope and spirit of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A system for providing power to subsea equipment, comprising:
a subsea power supply;
a subsea load operably coupled to the subsea power supply to selectively receive operational power from the subsea power supply;
a subsea charger electrically coupled to the subsea power supply and configured to charge the subsea power supply, wherein the subsea charger comprises a power converter comprising multiple silicon carbide (SiC) switches; and
at least one power generation unit operably coupled to the subsea power supply charger.

2. The system of claim 1, wherein the subsea power supply is a subsea battery or a subsea uninterruptible power supply (UPS).

3. The system of claim 1, wherein the subsea charger comprises an enclosure suitable for placement subsea and the power converter is disposed in the enclosure.

4. The system of claim 1, wherein the subsea charger is a standalone component separate from and coupled to the subsea power supply.

5. The system of claim 1, wherein the subsea charger is integrated into the subsea power supply.

6. The system of claim 1, further comprising a subsea umbilical configured to transmit AC power and coupling the at least one power generation unit to the subsea charger.

7. The system of claim 6, wherein the subsea charger is a charger/inverter.

8. The system of claim 1, further comprising a DC/fiber optic (FO) cable configured to transmit DC power and coupling the at least one power generation unit to the subsea charger.

9. The system of claim 8, wherein the subsea charger is integrated with a subsea node of the DC/FO cable.

10. The system of claim 8, wherein the power converter of the subsea charger is a DC buck converter or a DC boost converter.

11. The system of claim 1, wherein the at least one power generation unit comprises an onshore power generation station or a grid connection.

12. The system of claim 1, wherein the at least one power generation unit comprises an offshore power generation station.

13. The system of claim 1, wherein the at least one power generation unit is for generating renewable energy, wherein the renewable energy is generated from wind, solar, wave, sea currents, or a combination thereof.

14. The system of claim 1, wherein the subsea load comprises a subsea control unit, a subsea monitoring unit, a subsea processing unit, or a pressure protection system.

15. The system of claim 1, wherein the subsea power supply is configured to supply from about 5 to about 1,000 kilowatts of power.

16. The system of claim 1, wherein the subsea charger is located at a water depth of up to about 3,000 meters.

17. A method, comprising:
transmitting power from at least one power generation unit to a subsea charger;
charging a subsea power supply via the subsea charger, wherein the subsea charger comprises a power converter comprising multiple silicon carbide (SiC) switches; and
selectively supplying power to a subsea load via the subsea power supply.

18. The method of claim 17, further comprising:
supplying power to the subsea load via an umbilical or DC/fiber optic (FO) cable; and
upon detecting an interruption in power from the umbilical or DC/FO cable, supplying power to the subsea load from the subsea power supply.

19. The method of claim 17, further comprising transmitting AC power from the at least one power generation unit to the subsea charger via a subsea umbilical, wherein the subsea charger is integrated with the subsea power supply.

20. The method of claim 17, further comprising transmitting DC power from the at least one power generation unit to the subsea charger via a DC/FO cable, wherein the subsea charger is integrated with a subsea node of the DC/FO cable.
